(19) United States
(12) Patent Application Publication
(10) Pub. No.: US 2019/0211616 A1
(43) Pub. Date: Jul. 11, 2019

(54) DOOR COMPRISING KNOTTY SURFACE AND METHOD OF MAKING THE SAME

(71) Applicant: Plastpro 2000, Inc., Los Angeles, CA (US)

(72) Inventors: Scott Evert JOHNSON, Kingsville, OH (US); Jared Andrew GARRETT, Mentor, OH (US); Shirley WANG, Los Angeles, CA (US)

(73) Assignee: Plastpro 2000, Inc., Los Angeles, CA (US)

(21) Appl. No.: 16/239,582

(22) Filed: Jan. 4, 2019

Related U.S. Application Data
(60) Provisional application No. 62/614,627, filed on Jan. 8, 2018.

(51) Int. Cl. E06B 3/70; B44F 9/02; B44C 5/04; B29C 33/38; B29C 33/42

(52) U.S. Cl. CPC E06B 3/7001; B44F 9/02; B44C 5/0423; B29L 2031/724; B29C 33/424; E05Y 2900/132; B29C 33/3842

(57) ABSTRACT

A method for making a door skin or making a door is provided. A wood board is first provided. The wood board comprises a surface having a first texture with a first plurality of grains, and at least one knot, which has a predetermined depth of crack. The surface of the wood board is scanned to obtain a first profile of the first texture. The first profile of the first texture is modified to provide a second profile of the second texture, which includes a second plurality of grains and the at least one knot. A mold comprising a metal surface is formed based on the second profile of the second texture. A door skin is molded from a polymer composite using the mold so as to provide an exterior surface having the second plurality of grains and the at least one knot.

### PRIORITY CLAIM AND CROSS-REFERENCE

This application claims the benefit of U.S. Provisional Application No. 62/614,627, filed Jan. 8, 2018, which application is expressly incorporated by reference herein in its entirety.

### FIELD

The disclosure relates to a door generally. More particularly, the disclosed subject matter relates to a door having one or more skins having knotty or otherwise textured surface, and the method of making the same.

### BACKGROUND

Wooden doors have a pleasing appearance and a solid feel. Natural wood such as Alder wood having a rustic, knotty appearance is particularly popular. While the appearance of natural wood is aesthetically pleasing, wood is susceptible to damage caused by long-term exposure to humid or dry air, weather, and insect pests. The splitting and cracking are inherent to knotty wood. In addition, wooden doors are expensive to make. Natural wood may not have consistent grain that result from knots.

Composite door structures are generally more resistant to weathering and/or physical stress than natural wood. Composites of wood fiber and a polymer resin or glass-fiber reinforced polyester resins may be used to manufacture door and window units. But the products may not be as aesthetically pleasing as natural wood. Glass-fiber reinforced polyester resins are less aesthetically pleasing than wood-polymer composites.

### SUMMARY

The present disclosure provides a door skin or a door having the appearance and texture of knotty wood, and a method of making the same. More particularly, the present disclosure provides a door comprising one or more skins having knotty features simulating natural wood, such as Alder, pine, or any other wood.

In one aspect, a method for making a door skin or making a door is provided. A wood board or panel is first provided. The wood board comprises a surface having a first texture with a first plurality of grains, and at least one knot, which has a predetermined depth of crack. The surface of the wood board is scanned to obtain a first profile of the first texture. The first profile of the first texture is modified (or edited) to provide a second profile of the second texture, which includes a second plurality of grains and the at least one knot. A mold comprising a metal surface is formed based on the second profile of the second texture. A door skin is molded from a polymer composite using the mold so as to provide an exterior surface having the second plurality of grains and the at least one knot.

In some embodiments, the wood board is made of Alder, pine, maple, or any other natural wood. The predetermined depth of crack of the at least knot is at least 0.5 millimeter, for example, about 0.76 millimeter. In some embodiments, about 10% to about 30% of the first plurality of grains are selectively removed during the step of modifying (e.g., digitally editing) the first profile of the first texture to provide the second plurality of grains. The size of the at least one know may be increased in some embodiments.

In some embodiments, the metal surface has a negative or complementary image of the second plurality of grains and the at least one knot. A peak or valley on the metal mold surface is matched with a respective valley (corresponding to the peak), or a peak (corresponding to the valley) on the second texture. The negative or complementary image has a depth profile corresponding to that in second texture in some embodiments. The step of forming the mold comprises etching the metal surface with an acid. In some embodiments, the step of forming the mold further comprises etching the metal surface using laser after acid etching.

In some embodiments, the door skin is molded using a material comprising a polymer composite such as glass fiber reinforced polyester, polybutadiene or polyvinyl chloride.

In some embodiments, the method further comprises staining the door skin by applying a staining composition onto the exterior surface of the door skin. The resulting door skin or door surface has a natural wood appearance and/or texture including knots and/or grains. The exterior surface of the door skin or the door may have different staining tones. For example, the door skin includes dual staining tones after stained in some embodiments. For an area where about 10% to about 30% of the first plurality of grains are selectively removed, the area may show a lighter tone compared to other area having more grains.

In some embodiments, a method provided in the present disclosure comprises the following steps. A wood board comprising a surface having a first texture with a first plurality of grains and a first plurality of knots is provided. The first plurality of knots have a first depth relative to the surface. The surface of the wood board is scanned to obtain a first profile of the first texture. The first profile of the first texture is modified to provide a second profile of the second texture. The second texture includes a second plurality of grains and a second plurality of knots. A mold comprising a metal surface is provided based on the second profile of the second texture, through a first etching step and a second etching step. The door skin is molded using the mold so as to provide an exterior surface having the second plurality of grains and the second plurality of knots. In some embodiments, during the modifying the first profile of the first texture, about 10% to about 30% of the first plurality of grains are selectively removed to provide the second plurality of grains. The second plurality of knots are modified from the first plurality of knots. Each of the second plurality of knots is larger than, and may be deeper than, a respective knot in the first plurality of knots. In the two etching steps, the metal surface is first etched with an acid, followed by using laser. After molded, the door skin is stained by applying a staining composition onto the door skin. The door skins have two different color tones.

In another aspect, a door having the resulting skin is provided. The door comprises at least two skins including a first skin providing a front surface and a second skin providing a back surface. Each skin has an exterior surface with the at least one knot and the second plurality of grains, which provide rustic and knotty appearance similar to a natural wood such as Alder. The skins and resulting doors also have good mechanical performance and durability.

The door further comprises at least one core between the two skins, stiles aligned vertically along two vertical edges of the door, and rails aligned horizontally along two horizontal edges of the door. In some embodiments, the skins comprise a material of a glass fiber or mineral reinforced polymer composite. The polymer can be any suitable polymer, for example, cured from unsaturated polyester or polybutadiene. The door has a rectangular shape and the core is disposed between the stiles and the rails. In some embodiments, the stiles comprise laminated veneer lumber (LVL), and the rails comprise a composite comprising wood and polyvinyl chloride.

### BRIEF DESCRIPTION OF THE DRAWINGS

The present disclosure is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1A is a plan view of an exemplary door in accordance with some embodiments.

FIG. 1B is a cross-sectional view taken along horizontal line A-A in FIG. 1A.

FIG. 1C is a cross-sectional view taken along vertical line B-B in FIG. 1B.

FIGS. 1D and 1G show enlarged details of the exemplary door of FIG. 1A as shown in FIG. 1B in accordance with some embodiments.

FIGS. 1E-1F are enlarged details of the exemplary door of FIG. 1A as shown in FIGS. 1A and 1C in accordance with some embodiments.

FIG. 2A is a flow chart illustrating an exemplary method for forming a door skin having at least one knot in accordance with some embodiments.

FIG. 2B is a flow chart illustrating an exemplary method for forming a mold for molding the door skin in accordance with some embodiments.

FIG. 3 is a plan view illustrating an exemplary Alder wood panel showing grains and knots.

FIGS. 4A-4C illustrate an exemplary method for making a mold including steps of acid etching and laser etching in accordance with some embodiments.

FIG. 5A is a plan view illustrating an exemplary door in accordance with some embodiments.

FIG. 5B is an enlarged view of a portion of the exemplary door of FIG. 5A.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

For purposes of the description hereinafter, it is to be understood that the embodiments described below may assume alternative variations and embodiments. It is also to be understood that the specific articles, compositions, and/or processes described herein are exemplary and should not be considered as limiting.

In the present disclosure the singular forms “a,” “an,” and “the” include the plural reference, and reference to a particular numerical value includes at least that particular value, unless the context clearly indicates otherwise. When values are expressed as approximations, by use of the antecedent “about,” it will be understood that the particular value forms another embodiment. As used herein, “about X” (where X is a numerical value) preferably refers to ±10% of the recited value, inclusive. For example, the phrase “about 8” preferably refers to a value of 7.2 to 8.8, inclusive; as another example, the phrase “about 8%” preferably (but not always) refers to a value of 7.2% to 8.8%, inclusive. Where present, all ranges are inclusive and combinable. For example, when a range of “1 to 5” is recited, the recited range should be construed as including ranges “1 to 4”, “1 to 3”, “1-2”, “1-2 & 4-5”, “1-3 & 5”, “2-5”, and the like. In addition, when a list of alternatives is positively provided, such listing can be interpreted to mean that any of the alternatives may be excluded, e.g., by a negative limitation in the claims. For example, when a range of “1 to 5” is recited, the recited range may be construed as including situations whereby any of 1, 2, 3, 4, or 5 are negatively excluded; thus, a recitation of “1 to 5” may be construed as “1 and 3-5, but not 2”, or simply “wherein 2 is not included.” It is intended that any component, element, attribute, or step that is positively recited herein may be explicitly excluded in the claims, whether such components, elements, attributes, or steps are listed as alternatives or whether they are recited in isolation.

The present disclosure provides a door skin or a door having knotty wood features, and a method of making the same. More particularly, the present disclosure provides a door comprising one or more skins having knotty features simulating natural wood such as Alder or pine.

A door may comprise at least two skins including a first skin (e.g., a front skin) and a second skin (e.g., a back skin) which provide a first (e.g., a front) surface and a second (e.g., a back) surface. The skins may comprise a material of a glass fiber reinforced or mineral filled polymer composite, in which the polymer can be any suitable polymer, for example, cured from unsaturated polyester or polybutadiene.

The door further comprises at least one core disposed between the front and the back surfaces, stiles aligned vertically along two vertical edges of the door, and rails aligned horizontally along two horizontal edges of the door. In some embodiments, the door comprises at least two stiles aligned in a first direction (e.g., a vertical direction), and at least two rails aligned in a second direction (e.g., a horizontal direction). The at least two stiles include a first stile providing a first edge of the door and a second stile providing a second edge of the door, with the first edge being parallel to the second end. The at least two rails include a first rail providing a third edge of the door and a second rail providing a fourth edge of the door, with the third and fourth edges being parallel to one another and perpendicular with respect to the first and second edges. The at least one core may be bonded to the stiles and rails using a glue. Such a glue can be an inorganic glue, a polymer hot melt adhesive (e.g., polyurethane or polyolefin based), or a thermosetting-based polymer adhesive (e.g., epoxy, urethane-based). The door may have a rectangular shape with the core disposed between the stiles and the rails. The stiles comprise laminated veneer lumber (LVL); and the rails comprise a composite comprising wood and polyvinyl chloride.

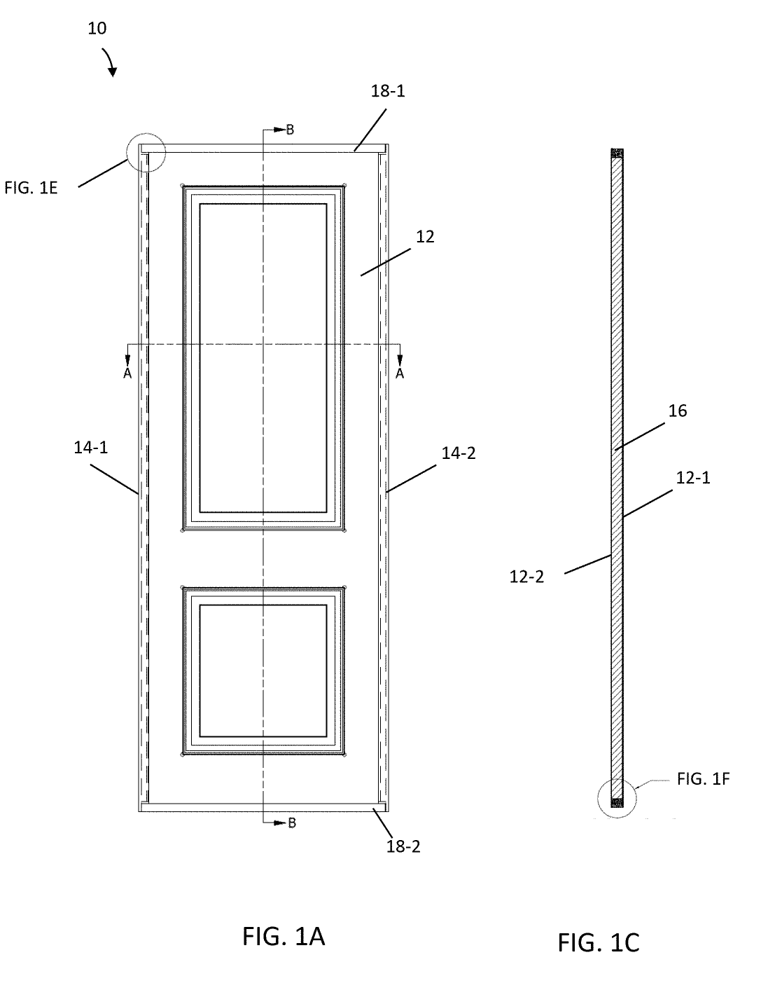

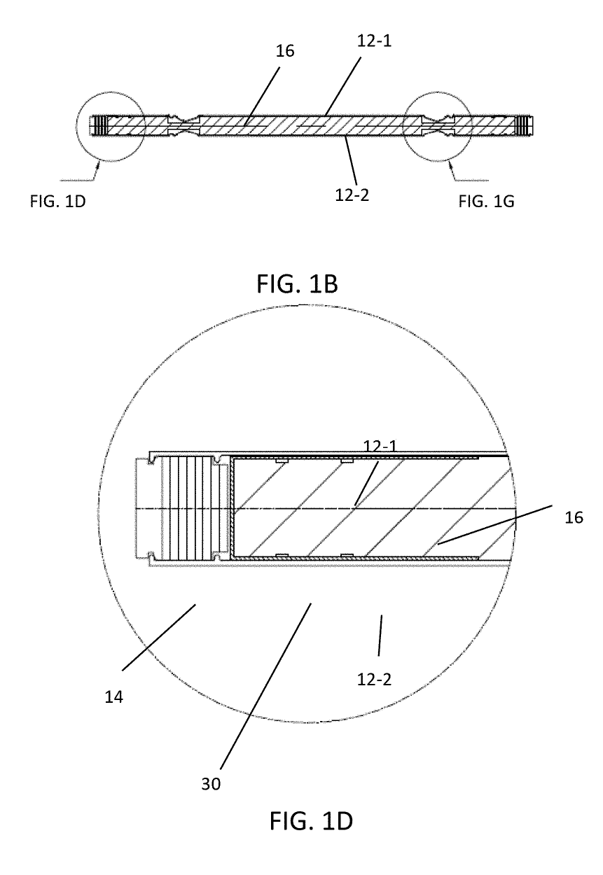

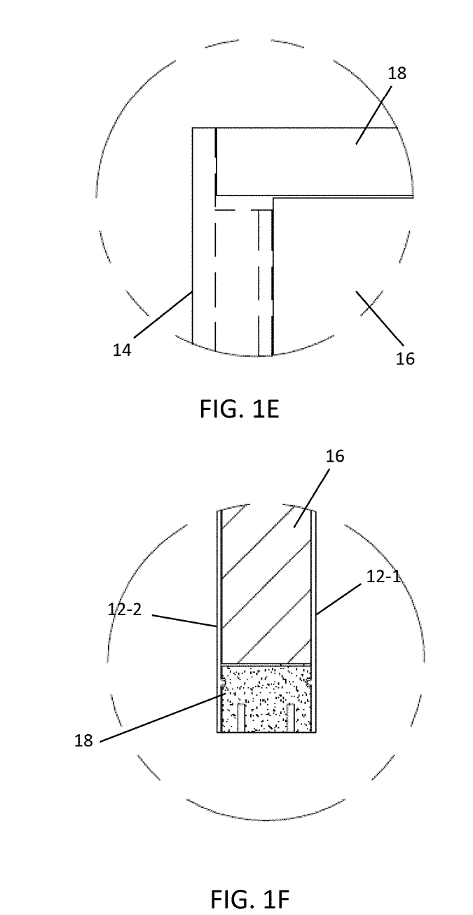

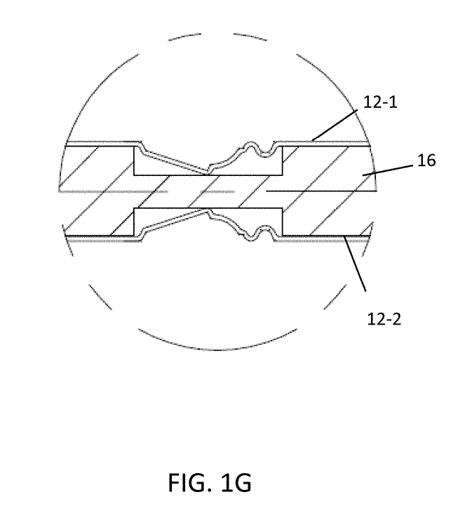

Referring to FIGS. 1A-1G, an exemplary door 10 in accordance with some embodiments comprises skins 12 comprising a first skin 12-1 and a second skin 12-2 forming the front and back surfaces of the exemplary door 10, vertical stiles 14 (including, for example, a left stile 14-1 and a right stile 14-2), at least one core 16, and horizontal rails 18 (including, for example, a top rail 18-1 and a bottom rail 18-2). The at least one core 16 is disposed between the first skin 12-1 and a second skin 12-2. The core 16 is also disposed between left and right stiles 14-1, 14-2, and between top rail and bottom rails 18-1, 18-2. In some embodiments, the at least one core 16 includes one or more pieces of cores, which are encased by the skins 12, stiles 14, and rails 18.

In some embodiments, the skins 12 comprise fiber glass composite or any other suitable material. The stiles 14 are made of laminated veneer lumber (LVL) or any other suitable material. The rails 18 are made of a wood flour/PVC (polyvinyl chloride) composite or any other suitable material. In some embodiments, the skins 12 may have ribs and flanges, while the stiles 14 and the rails 18 contain grooves. The ribs and flanges may be inserted into corresponding grooves to include mechanical interlocking.

The skins 12 comprise a match-molded high-compression unsaturated polyester and or poly-butadiene, glass-fiber-reinforced, mineral-filled composite material. Fiberglass exterior doors are fully enveloped in a composite material that is resistant to water absorption, and impact.

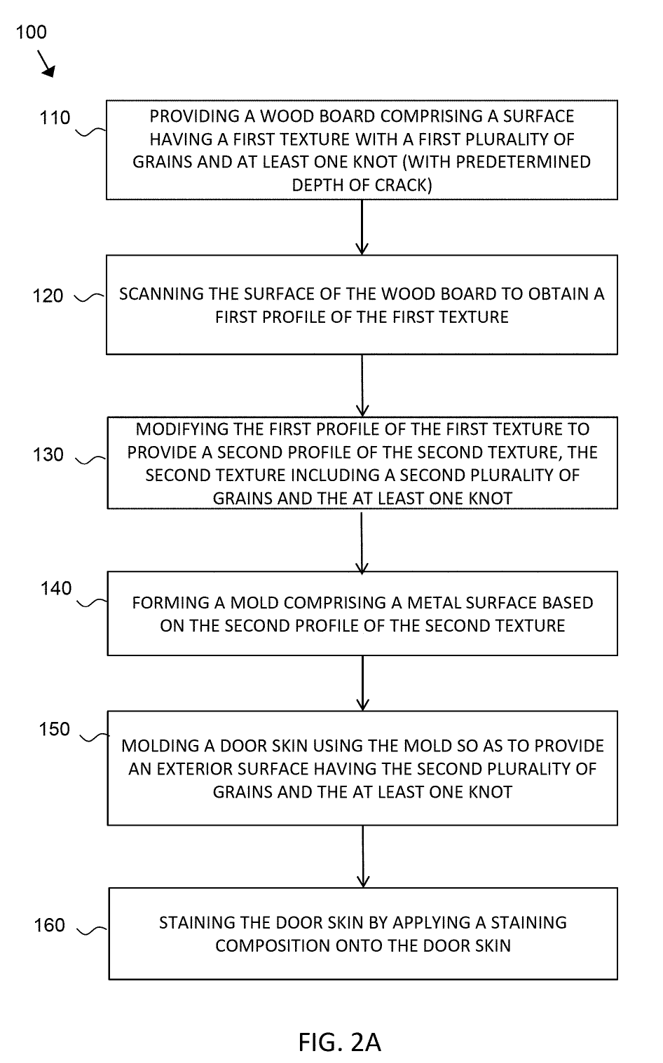

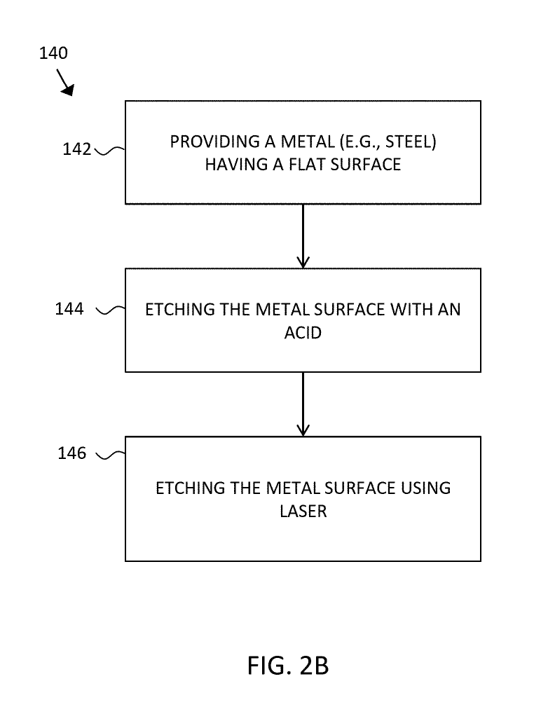

The present disclosure provides a door skin having an exterior surface having knotty features. In one aspect, a method for making a door skin or a door is provided. Referring to FIG. 2A, an exemplary method 100 is illustrated.

At step 110, a wood board is first provided. This wood board is used as a template, which a door skin is made to simulate the texture of the wood board. The wood board comprises a surface having a first texture with a first plurality of grains, and at least one knot. The at least one knot has a first depth of crack. In some embodiments, the first depth in the at least one knot are selected to meet a certain predetermined criteria, for example, a fixed depth, or a depth relative to an outermost surface or relative to the thickness of a door skin to be made based on this wooed board as a template. In some embodiments, the wood board is made of Alder, pine, maple, or any other natural wood.

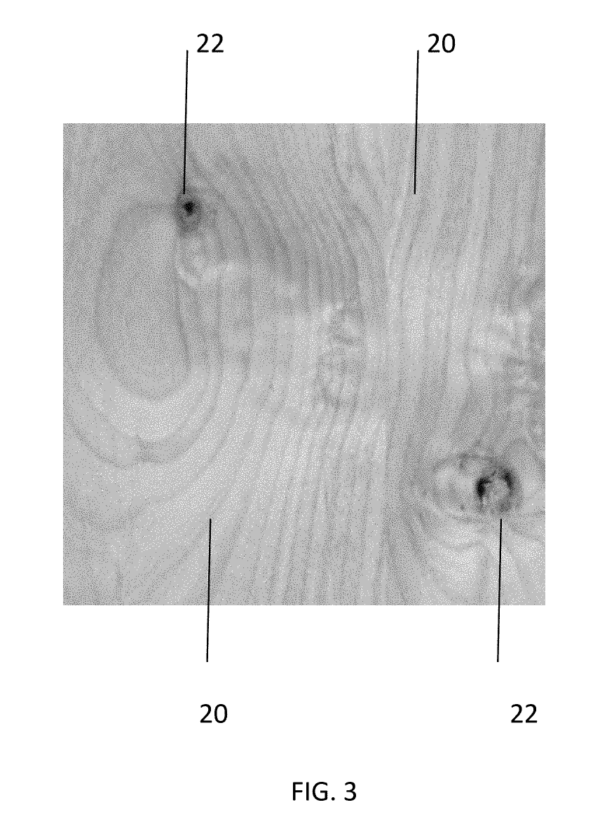

FIG. 3 illustrates one example of a piece of Alder wood panel having grains 20 and knots 22. A grain is crack or depression that extends generally in a first direction, such as a longitudinal direction. Reference to a “grain” will be understood to encompass a structural feature having an arced or curved shape or having a shaped like a “v” such that the grain extends in a first direction, comes to a near point or arc, and then extends back in a second direction that is nearly opposite the first direction. A knot is a visible and tangible feature in wood that is of a generally circular or oval shape and has a shade or color that differs (e.g., is darker or lighter) than the surrounding area.

In some embodiments, the predetermined depth of crack of the at least knot is at least 0.5 millimeter, for example, to about 0.76 millimeter. In some embodiments, the targeted door skin has a thickness of about 0.075 inch (1.905 mm). The predetermined depth of crack may be about 0.030 inch (0.762 mm), about 40% of the thickness of the door skin. The predetermined depth of crack provides a realistic appearance.

At step 120, the surface of the wood board is scanned to obtain a first profile of the first texture. The detailed texture of the wood board is scanned. Such a profile may include 2-D and/or 3-D images stored in a computer, such as in a non-transitory computer-readable storage media.

At step 130, the first profile of the first texture is modified (or edited on a computer) to provide a second profile of the second texture, which includes a second plurality of grains and the at least one knot. If no modification is made, the first profile and the second profile are the same. In some embodiments, during the step of modifying (e.g., digitally editing) the first profile of the first texture, about 10% to about 30% of the first plurality of grains are selectively removed to provide the second plurality of grains. In some embodiments, the at least one knot can be modified to increase its size. The knot size may be increased by any suitable percentage, for example, 10%, 25%, 50%, 75%, 100%, 150%, 200%, or any percentage in between these numbers. Thus the knot size in the molded door skin will be significantly larger than that in the wood board. In some embodiments, the at least one knot has a generally circular or oval shape at a size (diameter or the longest dimension) of about 1 inch (2.54 cm) to 4 inches (10.16 cm), for example, 1-1.25 inch (2.54-3.12 cm), or 2-4 inches (5.08-10.16 cm). In some embodiments, a size in a range from about 2 inches (5.08 cm) to about 4 inches (10.16 cm) is more preferable. The first depth of crack of the at least one knot can be maintained the same or be increased.

At step 140, a mold is formed based on the second profile of the second texture. In some embodiments, the mold includes a metal (e.g., steel) surface having a negative or mirror image of the second plurality of grains and the at least one knot. Although the mold is described as including metal, one of ordinary skill will understand that the mold may include other materials. The second profile can be projected onto a surface of the mold, and the mold surface is etched to form the textured feature. Overall the mold surface is used to reflect the desired grain and knots on the subsequently molded skins, which provides desired features simulating natural wood such as Alder wood. For example, in some embodiments, on the mold surface, the areas corresponding to the second plurality of grains may be etched. The areas corresponding to the at least knot except the crack may be etched.

Referring to FIG. 2B, an exemplary method 140 of forming the mold may comprise one or more of steps 142, 144, and 146. The structure at each step is illustrated in FIGS. 3A, 3B, and 3C, respectively.

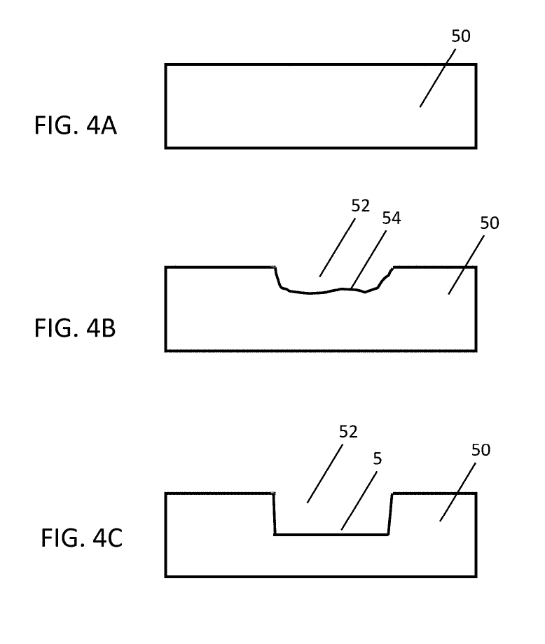

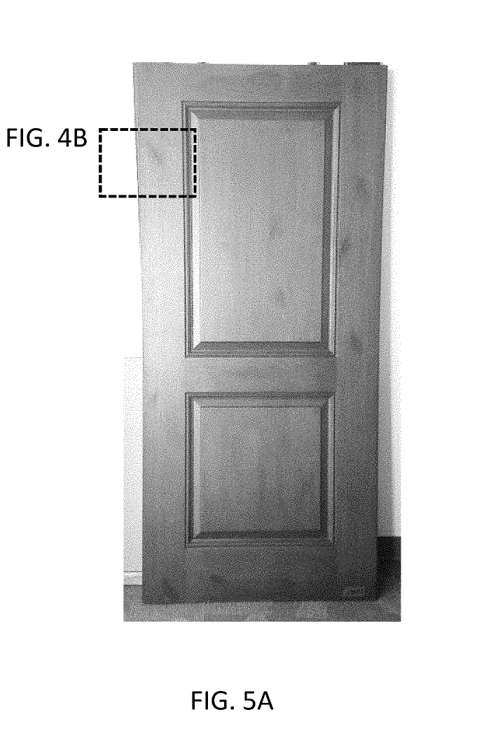

At step 142, a piece of mold material 50 such as steel (as illustrated in FIG. 4A) is provided. At step 144, the surface of the material 50 is etched with an acid. The resulting structure is illustrated in FIG. 4B. The surface of the material 50 may contain shallow trenches 52 having irregular bottom surface 54. In some embodiments, the material 50 such as steel is placed in an acid bath at step 144. At step 146, the surface of the material 50 is further etched using a laser after the material surface has been acid-etched. The resulting structure is illustrated in FIG. 4C. The trenches 52 have higher depth and a smooth bottom surface 56. The laser-etching step provides deeper and more detailed features on the knots so that the knots on the molded door skin will absorb more stains in the subsequent staining process after molding. The laser etching provides deeper channels, which may have a flat bottom. The depth of the channels at each point is the depth difference among different structural features corresponding to knots and grain. Such channels can provide more significant features such as knots and grains, which may absorb more stain in subsequent steps. In some embodiments, the flat bottom surface 56 may provide smooth surface between two cracks in the molded door skin.

Although laser etching is described as being used for the second etching step, other suitable techniques may be used for a second etching step. For example, in some embodiments, the material is exposed to a second acid etching step. The inventors have found, however, that laser etching advantageously provides enhanced control compared to performing a second acid etching step and leaves a crack or channel that absorbs a stain better than a crack formed by acid etching. As such, the use of the laser etching enables an improved two-tone wood feature to be created, which mimics the appearance of natural wood.

In some embodiments, after acid etching (step 144) is performed, a combination of laser etching and acid etching may be used at step 146. In some embodiments, the laser can be used for welding specified portions to provide channels having deep and flat bottom surfaces.

At step 150, a door skin is molded from a polymer composite using the mold so as to provide an exterior surface having the second plurality of grains and the at least one knot.

In some embodiments, the door skin is molded using a material comprising a polymer composite such as glass fiber reinforced polyester, polybutadiene or polyvinyl chloride.

At step 160, the door skin is stained by applying a staining composition onto the exterior surface of the door skin. The resulting door skin or door surface has a natural wood appearance including knots and grains. The exterior surface of the door skin or the door may have different staining tones. For example, the door skin includes dual staining tones after stained in some embodiments. For an area where about 10% to about 30% of the first plurality of grains are selectively removed (e.g., on the growth rings), the area may show a lighter tone compared to other area having more grains. The grains on the mold skins tend to absorb more stain, resulting in more darkened surface. When the grains are selectively removed, less stain will be absorbed, resulting in a lighter staining tone. So a two-toned effect will be provided. In some embodiments, no grain is removed, a monotone staining effect is provided.

In some embodiments, the staining process at step 160 can be performed after wiping the staining chemicals onto a door surface and then brushing the door. A marker can be used to highlight a knotty area. The stain is applied onto the knotty area by poking the knots with the toe of a bristle or brush along the knotty pattern. The staining chemicals can be water-based or oiled based. The staining process can be performed at or above room temperature. In some embodiments, the staining process is preferably performed at a temperature of about 15 to about 25° C.

In some embodiments, the surface can be painted in any suitable color with or without staining.

The method of making a door may further comprise bonding the at least one core with the stiles aligned along two first edges of the core and aligning the rails two second edges of the core, and applying at least two skins to the at least one core. A first skin (e.g., a front skin) is applied onto a front side and a second skin (e.g., back skin) is applied onto a back side of the at least one core. Forming the door also includes other steps for bonding and/or assembling the door. For example, for bonding the various components together to assemble the door, a number of bonding agents may be used, such as an inorganic glue (different from the inorganic bonding agent for the core), a polymer hot melt adhesive (e.g., polyurethane or polyolefin based), or a thermosetting based polymer adhesive (e.g., epoxy, urethane-based). In some embodiments, polyurethane reactive hot melt adhesive or a polyolefin based adhesive is used for bonding, for example, a composite cap to the LVL or Engineered wood.

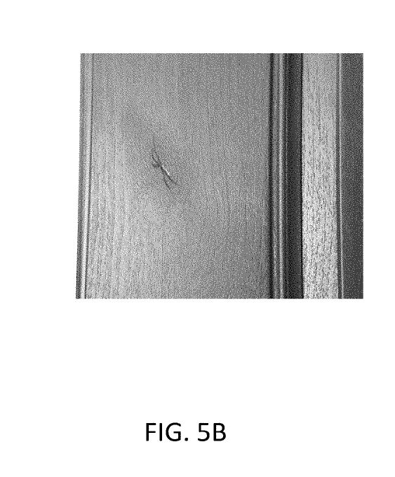

The present disclosure also provides the resulting door. FIG. 5A illustrates an exemplary door in accordance with some embodiments. FIG. 5B is an enlarged view of a portion of the exemplary door of FIG. 5A. FIG. 5B may have patterns similar to that in FIG. 3, and may have reduced amount of grains in some embodiments. FIGS. 3 and 5A-5B are used for illustration only. For example, the resulting door with stains may appear to be darker than what is shown in the drawings.

The present disclosure also provide a kit or a product comprising the components described herein, and a resulting door assembly.

Although the subject matter has been described in terms of exemplary embodiments, it is not limited thereto. Rather, the appended claims should be construed broadly, to include other variants and embodiments, which may be made by those skilled in the art.

What is claimed is:

1. A method comprising:
scanning a surface of a wood board to obtain a first profile of a surface of the wood board, the surface having a first texture with a first plurality of grains and at least one knot, the at least one knot having a first depth relative to the surface;
modifying the first profile of the first texture to provide a second profile of the second texture, the second texture including a second plurality of grains and the at least one knot; and
forming a mold comprising a mold surface based on the second profile of the second texture, through a first etching step and a second etching step.

2. The method of claim 1, further comprising:
molding a door skin using the mold so as to provide an exterior surface having the second plurality of grains and the at least one knot.

3. The method of claim 1, wherein the wood board is made of Alder, and the predetermined depth of crack of the at least knot is at least 0.5 millimeter.

4. The method of claim 1, wherein modifying the first profile of the first texture includes selectively removing about 10% to about 30% of the first plurality of grains to provide the second plurality of grains.

5. The method of claim 1, wherein the mold surface has a negative of the second plurality of grains and the at least one knot.

6. The method of claim 1, wherein the first etching step is a step of etching the mold surface with an acid.

7. The method of claim 6, wherein the second etching step is a step of etching the mold surface using laser.

8. The method of claim 1, wherein the door skin is molded using a material comprising a polymer composite.

9. The method of claim 8, wherein the polymer composite is glass fiber reinforced polyester, polybutadiene or polyvinyl chloride.

10. The method of claim 1, further comprising staining the door skin by applying a staining composition onto the door skin.

11. The method of claim 10, wherein the door skin includes dual staining tones after stained.

12. A method comprising:
scanning a surface of a wood board to obtain a first profile of a surface of the wood board, the surface having a first texture with a first plurality of grains and at least one knot, the at least one knot having a first depth relative to the surface;
modifying the first profile of the first texture to provide a second profile of the second texture, the second texture including a second plurality of grains and a second plurality of knots;
forming a mold comprising a metal surface based on the second profile of the second texture, through a first etching step and a second etching step; and
molding a door skin using the mold so as to provide an exterior surface having the second plurality of grains and the second plurality of knots.

13. The method of claim 12, wherein modifying the first profile of the first texture includes selectively removing about 10% to about 30% of the first plurality of grains to provide the second plurality of grains.

14. The method of claim 12, wherein the second plurality of knots are modified from the first plurality of knots, and each of the second plurality of knots is larger than a respective knot in the first plurality of knots.

15. The method of claim 12, wherein the first etching step is a step of etching the metal surface with an acid, and the second etching step is a step of etching the metal surface using laser.

16. The method of claim 12, further comprising staining the door skin by applying a staining composition onto the door skin, wherein the door skins have two different tones.
